(19) United States
(12) Patent Application Publication
(10) Pub. No.: US 2006/0007171 A1
(43) Pub. Date: Jan. 12, 2006

(54) EMI resistant balanced touch sensor and method

(76) Inventors: Roger D. Burdi, Grand Rapids, MI (US); Michael Jon Taylor, Longmont, CO (US)

Correspondence Address: JENNER & BLOCK, LLP, ONE IBM PLAZA, CHICAGO, IL, 60611, US

(21) Appl. No.: 10/874,546

(22) Filed: Jun. 24, 2004

(51) Int. Cl. G09G 5/00

(52) U.S. Cl. 345/173

(57) ABSTRACT

An EMI resistant, low impedance touch sensor detects contact of a dielectric substrate by an operator's appendage or body part, a metal object, or the proximity of a moving fluid/gas interface. The touch sensor includes a first conductive electrode pad and a second conductive electrode of substantially equal area which is spaced from the first electrode by a channel of non-conductive dielectric. The first and second electrodes are optionally disposed on the same surface of the substrate. An active electrical component including an oscillator and a differential sensing circuit is located on the substrate proximate the first and second electrodes and is electrically coupled to the first and second electrodes. Noise or interference signals appearing on both the first and second electrodes, being of substantially equal area, are subtracted from one another through to provide common mode rejection of EMI.

### FIELD OF THE INVENTION

The present invention relates to sensors or control actuators for detecting the presence of an operator's appendage or body part, a metal object, or the proximity of a moving fluid/gas interface.

### BACKGROUND OF THE INVENTION

Electronic or capacitive solid state switches and touch panels are used in various applications to replace conventional mechanical switches for applications including kitchen stoves, microwave ovens, and the like. Unlike mechanical switches, touch panels contain no moving parts to break or wear out. Mechanical switches used with a substrate require some type of opening through the substrate for mounting the switch. These openings, as well as openings in the switch itself, allow dirt, water and other contaminants to pass through the substrate to become trapped within the switch. Certain environments contain a relatively large volume of contaminants which can pass through substrate openings, causing electrical shorting or damage to the components behind the substrate. However, touch panels can be formed on a continuous substrate sheet without any openings in the substrate. Also, touch panels are easily cleaned, having no openings or cavities to collect contaminants.

Existing touch panel designs provide touch pad electrodes attached to both sides of the substrate; i.e., on both the “front” surface of the substrate and the “back” surface of the substrate. Typically, a tin antimony oxide (TAO) electrode is attached to the front surface of the substrate and additional electrodes are attached to the back surface. The touch pad is activated when a user contacts the TAO electrode. Such a design exposes the TAO electrode to damage by scratching, cleaning solvents, and abrasive cleaning pads. Furthermore, the TAO electrode adds cost and complexity to the touch panel.

Touch panels often use a high impedance design which may cause the touch panel to malfunction when water or other liquids are present on the substrate. This presents a problem in areas where liquids are commonly found, such as a kitchen. Since the pads have a higher impedance than water, the water acts as a conductor for the electric fields created by the touch pads. Thus, the electric fields follow the path of least resistance; i.e., the water. Also, due to the high impedance design, static electricity can cause the touch panel to malfunction. The static electricity is prevented from quickly dissipating because of the high impedance of the touch pad.

Existing touch panel designs also suffer from problems associated with crosstalk between adjacent touch pads. Crosstalk occurs when the electric field created by one touch pad interferes with the field created by an adjacent touch pad, resulting in an erroneous activation such as activating the wrong touch pad or activating two pads simultaneously.

Prior touch panel designs provide individual passive pads. No active components are located in close proximity to the touch pads. Instead, lead lines connect each passive touch pad to active detection circuitry. The touch pad lead lines have different lengths, depending on the location of the touch pad with respect to the detection circuitry. Also, the lead lines have different shapes, depending on the routing path of the line. The differences in lead line length and shape cause the signal level on each line to be attenuated to a different level. For example, a long lead line with many corners may attenuate the detection signal significantly more than a short lead line with few corners. Therefore, the signal received by the detection circuitry varies considerably from one pad to the next. Consequently, the detection circuitry must be designed to compensate for large differences in signal level. Touch panel designs with non-uniform lead line length and shape also respond to environments with Electro-Magnetic Interference (EMI) in unpredictable ways, and may not conform to increasingly rigid Electro-Magnetic Compatibility (EMC) standards.

Many existing touch panels use a grounding mechanism, such as a grounding ring, in close proximity to each touch pad. These grounding mechanisms represent additional elements which must be positioned and attached near each touch pad, thereby adding complexity to the touch panel. Furthermore, certain grounding mechanisms require a different configuration for each individual touch pad to minimize the difference in signal levels presented to the detection circuitry. Therefore, additional design time is required to design the various grounding mechanisms.

Other prior touch sensing systems also respond to environments with Electro-Magnetic Interference (EMI) in unpredictable ways, and may not conform to increasingly rigid Electro-Magnetic Compatibility (EMC) standards.

There is a need, therefore, for a system for sensing an operator's inputs that conforms to stringent Electro-Magnetic Interference EMI tolerance and EMC standards.

### SUMMARY OF THE INVENTION

The touch sensor and method of present invention solves the above-mentioned problems and others associated with existing designs and conforms to stringent EMI tolerance and EMC standards by providing an active, low impedance touch sensor attached to a dielectric substrate. The inventive touch sensor has a first conductive electrode pad of a selected pad area and a second conductive electrode which substantially surrounds the first electrode in a spaced apart relationship. The second electrode defines a conductive surface area that is substantially equal to the selected pad area of the first electrode. The first electrode pad may be a closed, continuous geometric shape with an area providing substantial contact coverage by a human appendage. An active electrical component is placed in close proximity to the electrodes.

Noise or interference signals appearing on both the first and second electrodes, being of substantially equal area, are, in effect, subtracted from one another to provide a common mode rejection of EMI.

The inventive touch pad can be used in place of existing touch pads or to replace conventional switches. The touch pad is activated when a user contacts the substrate with a human appendage, such as a fingertip. The touch pads can be used to turn a device on or off, adjust temperature, set a clock or timer, or any other function performed by a conventional switch. In addition to solving problems associated with existing touch pad designs, the present invention is especially useful in applications presently using membrane-type switches, such as photocopiers and fax machines. The inventive touch pad design operates with liquids present on the substrate and in the presence of static electricity. The touch pad is well suited for use in a kitchen or other environment where water, grease and other liquids are common, such as control panels for ranges, ovens and built-in cooktops.

In a preferred form, touch pad electrodes are attached to the back surface of a substrate. The back surface of the substrate is opposite the front or “touched” surface, thereby preventing contact of the electrodes by the user. Since the touch pad is not located on the front surface of the substrate, the pad is not damaged by scratching, cleaning solvents or any other contaminants which contact the front surface of the substrate. Furthermore, the cost and complexity of the touch panel is reduced since a TAO pad is not required on the front surface of the substrate.

In the preferred form, an oscillator is electrically connected to the inner and outer electrodes through gain tuning resistors and delivers a square-wave like signal having a very steep slope on the trailing edge. The oscillator signal creates an arc shaped transverse electric field between the outer electrode and the center electrode. The electric field path is arc-shaped and extends through the substrate and past the front surface, projecting transversely to the plane of the substrate. The inner and outer electrode signals are applied as common mode signals to the inputs of a differential sensing circuit and when the difference in response between the inner and outer electrodes is great enough, the sensing circuit changes state (e.g., from high to low). The sensing circuit state is altered when the substrate is touched by the controlled fluid.

In the preferred form, an active electrical component preferably configured as a surface mount application specific integrated circuit (ASIC), is located at each sensor. Preferably, the ASIC is connected to the center pad electrode and to the outer electrode of each sensor. The ASIC acts to amplify and buffer the detection signal at the sensor, thereby reducing the difference in signal level between individual sensors due to different lead lengths and lead routing paths. A plurality of sensors may be arranged on the substrate.

The applicants have discovered that an equal area or balanced pad electrode design provides improved electromagnetic immunity and works exceptionally well for sensing the presence of a human appendage. The noise or EMI immunity appears to stem from a common mode rejection of spurious noise or interference signals. This “common mode” rejection is attributable to the equal area of the center pad and the outer ring electrode, which appear to receive or be affected by spurious noise or interference signals substantially equally (when of substantially equal area), and so when one electrode's signal is subtracted from the other electrode's signal, the common noise/interference signals cancel one another. A sensor incorporating the balanced pad design is less expensive and smaller than designs requiring additional filtering circuits with chokes and capacitors or shielding.

The circuitry used to energize the electrodes and sense a change in the arc-shaped electric field generated by the electrodes is optionally incorporated in an ASIC or chip referred to as a TS100 chip and used to sense the presence of a human appendage (e.g., a finger), a metal object or a fluid interface with air. In the exemplary embodiment, the TS100 is used with a conductive printed circuit for the active sensor area with an inner pad electrode and outer ring electrode connected to the TS100 via biasing resistors and driven with a time varying field. A differential change in the resulting arc-shaped electric field is sensed through the inner pad and outer ring electrodes. Prior pads were of un-equal surface area and were observed to have limited immunity to EMI. The balanced, equal area electrodes (i.e., inner pad and outer ring) of the present invention have, preferably, near identical surface areas and result in a pad design that is highly immune to or tolerant of EMI. This EMI tolerance is also useful in configuring systems to meet stringent EMC criteria.

The balanced pad design and method of the present invention are also well suited for applications requiring the sensor(s) to be potted or sealed in an overmolded enclosure, because the potting or molding process affects the balanced differential electrodes equally and makes tuning the sensor more predictable and repeatable. The balanced pad designs have a more consistent, repeatable performance over time and over a wider range of environmental conditions including changes in temperature, humidity and presence of contamination.

The balanced pad design can be implemented on planar circuits, or can be incorporated into complex three-dimensional configurations using, for example, flexible substrates folded or molded in a 3-D arrangement to provide directional sensing.

The above and still further features and advantages of the present invention will become apparent upon consideration of the following detailed description of a specific embodiment thereof, particularly when taken in conjunction with the accompanying drawings, wherein like reference numerals in the various figures are utilized to designate like components.

### BRIEF DESCRIPTION OF THE DRAWINGS

FIG. 1 is a side elevation view, illustrating the conductive traces on a printed circuit board including the balanced pad sensor electrode pattern, showing arc-shaped electric field lines, in accordance with the present invention.

FIG. 2 is a plan view illustrating the component side layout of conductive traces on a printed circuit board including a balanced pad sensor electrode pattern, in accordance with the present invention.

FIG. 3 is a plan view illustrating the component side layout of conductive traces on a printed circuit board including a balanced pad sensor electrode pattern with a ground plane, in accordance with the present invention.

FIG. 4 is a schematic diagram illustrating the circuit components and conductive traces, in accordance with the present invention.

FIG. 5 is a plan view illustrating the outline of the components on the printed circuit board of FIGS. 2 and 4.

FIG. 6 is a side elevation view illustrating conductive traces on opposite sides of a printed circuit board including the double-sided balanced pad sensor electrode pattern.

FIG. 7 is a plan view illustrating the component side layout of conductive traces on one side of a printed circuit board including a two-sided balanced pad sensor electrode pattern.

FIG. 8 is a plan view illustrating the non-component side layout of conductive traces on the other side of the printed circuit board of FIG. 7.

FIG. 9a is a plan view illustrating a flat balanced pad sensor electrode pattern with offset pads.

FIG. 9b is a side elevational view of the flat balanced pad sensor electrode pattern with offset pads of FIG. 9a.

FIG. 10 is a side elevational view of a two-sided balanced pad sensor electrode pattern having inner and outer ring electrodes on opposite sides of a printed circuit board.

FIG. 11 is a plan view illustrating the bottom side layout of conductive traces on the printed circuit board of FIG. 10.

FIG. 12 is a plan view illustrating the top side layout of conductive traces on the printed circuit board of FIGS. 10 and 11.

FIG. 13 is a plan view illustrating a balanced pad sensor electrode pattern design implemented on a flexible substrate.

FIG. 14 is a perspective view illustrating the balanced pad sensor electrode pattern design of FIG. 13, with the flexible substrate wrapped in a three dimensional configuration to provide directional sensing, in accordance with the present invention.

FIG. 15 illustrates an edge view of a focused sensitivity balanced touch sensor having a dimpled substrate, in accordance with the present invention.

### DESCRIPTION OF THE PREFERRED EMBODIMENT

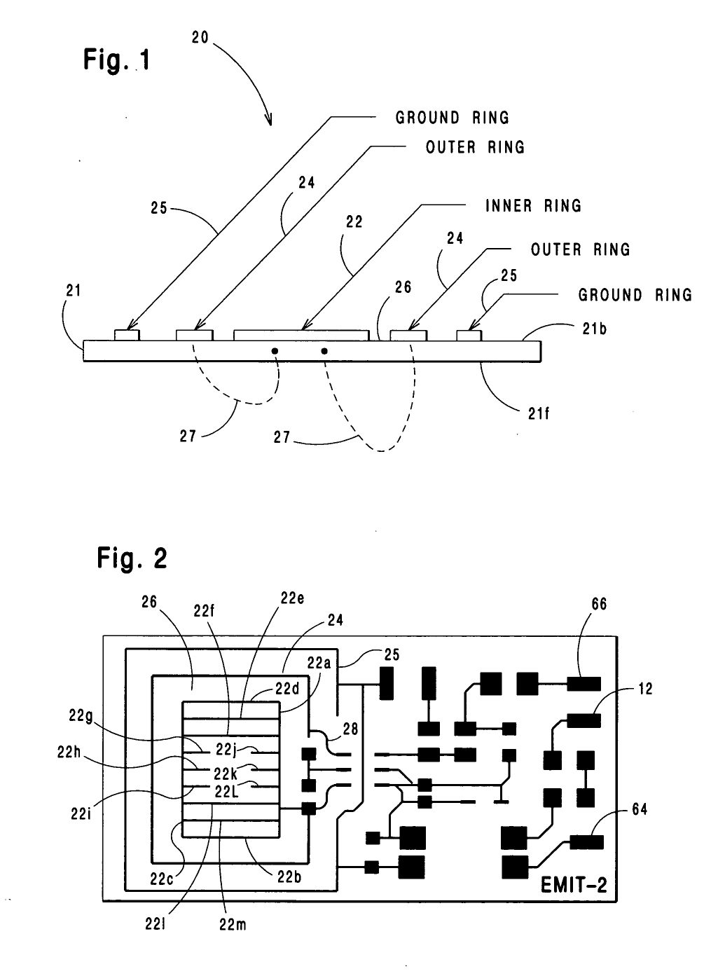

Referring to the exemplary embodiment illustrated in FIGS. 1-5, an EMI resistant, balanced touch sensor 20 includes conductive traces on a printed circuit board or substrate 21 carrying the balanced pad sensor electrode pattern with a first pad or inner electrode 22 within a second or outer electrode 24. Second electrode 24 defines a conductive surface area that is substantially equal to the pad surface area of the first electrode 22. An optional conductive ground ring 25 at least partly surrounds second electrode 24 to isolate one pad electrode from another or from the surrounding environment. As best seen in FIG. 1, the touch sensor's electric field lines 27 sense the presence of a user's finger, a metal object or a fluid/gas interface.

A single touch pad sensor 20 is shown in FIG. 1, attached to dielectric substrate 21. Substrate 21 preferably has a substantially uniform thickness and can be manufactured from any type of structurally supporting dielectric material such as glass, ceramic or plastic. Alternatively, the substrate may have a varying thickness including a depression, so long as substrate geometry varies in a controlled and reproducible manner. In a preferred embodiment, substrate 21 is manufactured from a fiber reinforced plastic or epoxy and has a uniform thickness of approximately 2 mm. The thickness of substrate 21 varies with the particular application such that a thicker substrate may be used where additional strength is required. Substrate 21 can be manufactured from a flexible material for use in applications where sensor 20 must conform to a non-planar shape or applications requiring a directional sensor.

If substrate 21 is manufactured from glass, the substrate can be as thin as approximately 0.1 mm and as thick as approximately 10 mm. If substrate 21 is manufactured from plastic, the substrate can be less than 1 mm thick, similar to the material used in plastic membrane switches. A thin substrate 21 may permit the touch pad to be operated by a user wearing a glove or mitten.

Substrate 21 has a front surface 21f opposite a back surface 21b (as best shown in FIG. 1). A user activates the touch pad sensor 20 by touching front surface 21f of substrate 21. As noted above, the touch pad sensor 20 includes a thin, conductive inner electrode 22 and a thin, conductive outer electrode 24 substantially surrounding the inner electrode. A non-conductive expanse of PCB surface or channel 26 is located between inner electrode 22 and outer electrode 24. Electrodes 22 and 24 are positioned such that channel 26 has a substantially uniform width, as seen in plan view.

For user control input or solid state touch switch applications, inner electrode 22 preferably has dimensions such that the electrode may be substantially covered by a user's fingertip or other appendage when touched. Testing has demonstrated that an equal area or balanced pad electrode design provides improved electromagnetic immunity and works exceptionally well for sensing the presence of a user's finger or a human appendage, a metallic object or the proximity of a moving a fluid/gas interface (e.g., indicating a fluid level).

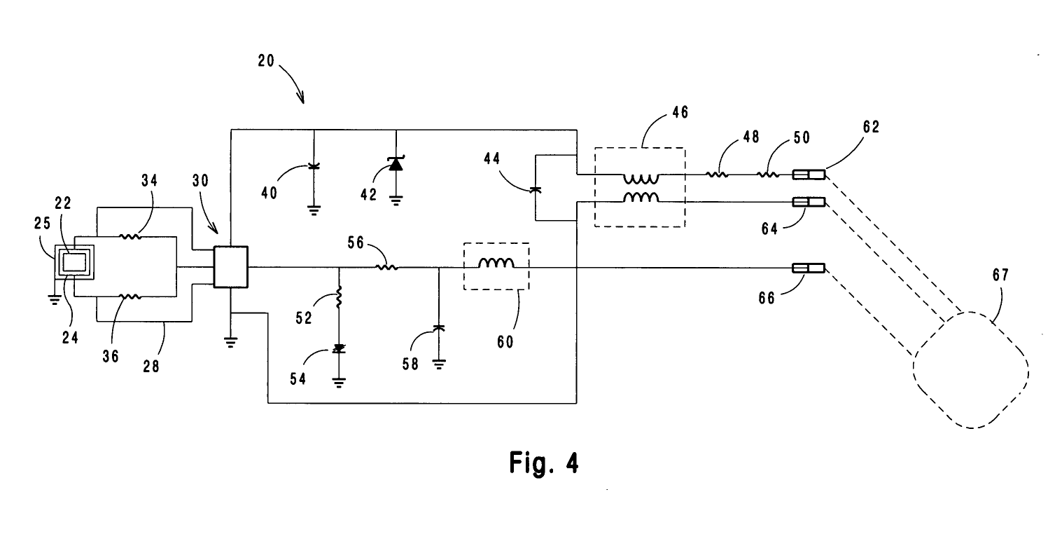

While not wishing to be bound to any particular theory, the noise or EMI immunity appears to stem from a common mode rejection of spurious noise or interference signals. This “common mode” rejection is attributable to the equal area of the inner pad 22 and outer ring 24, which receive or are affected by spurious noise or interference signals substantially equally (when of substantially equal area). When one electrode's signal is effectively subtracted from the other electrode's signal (e.g., as inputs to a differential circuit), the common noise/interference signals cancel one another. This results in high signal to noise ratio. Balanced touch sensor 20 incorporates the balanced pad design and is less expensive to manufacture and smaller than designs requiring additional filtering circuits with chokes and capacitors or shielding. The electrode's signals are subtracted from one another in a differential sensing circuit included as part of the TS100 integrated circuit 30 as shown in FIG. 4.

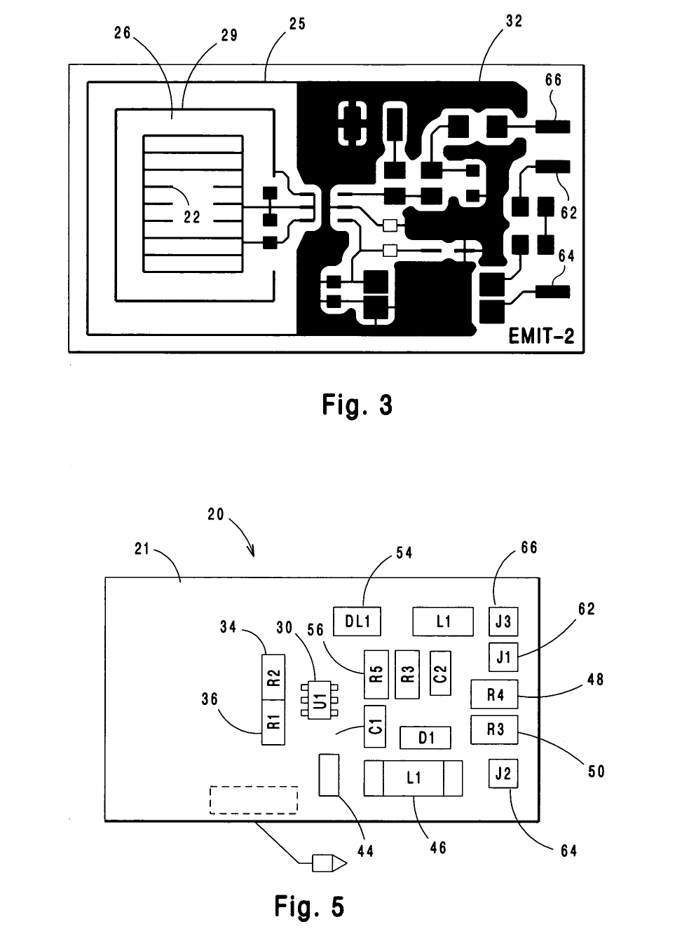

As best seen in FIGS. 2 and 3, inner electrode 22 is substantially rectangular in plan view and comprises a pattern of alternating conductive and non-conductive regions to provide a selected pad area of conductive material. Outer electrode 24 has a substantially rectangular shape in plan view which conforms to the shape of the inner electrode 22 and is spaced apart therefrom by non-conductive channel region 26. It will be understood that various closed, continuous geometric conductive shapes may also be used for inner electrode 22 including, but not limited to, rectangles, trapezoids, circles, ellipses, triangles, hexagons, and octagons. Regardless of the shape of inner electrode 22, outer electrode 24 substantially surrounds inner electrode 22 linearly in a spaced apart relationship with channel 26 providing the space between the electrodes. It will be further understood that various continuous geometric conductive shapes may also be used for the outer electrode 24 including, but not limited to, rectangles, trapezoids, circles, ellipses, triangles, hexagons, and octagons so long as outer electrode 24 substantially linearly surrounds the inner electrode 22.

Center electrode 22 may be a solid region of conductor or may have a plurality of apertures or a mesh or grid pattern. Preferably, center electrode 22 has a plurality of coplanar electrical contact points having the same electrical potential. Alternatively, center electrode may be a three dimensional shape not disposed in a single plane.

As best shown in FIGS. 2 and 4, a strobe line 28 is connected to outer electrode 24. The ASIC sensor IC provides an oscillator output pulse train or square wave signal to both inner electrode 22 and outer electrode 24. In the preferred embodiment, the oscillator signal is a square wave oscillating between 0 and +5 volts at a frequency of approximately 32 kHz.

As best shown in FIGS. 1 and 2, a balanced pad or electrode pattern has a conductive trace area for the inner electrode (e.g., inner pad 22) that is equal (or as equal as possible within PCB manufacturing tolerances) to the area of its corresponding outer electrode ring (e.g., outer electrode 24). Both inner electrode 22 and outer electrode 24 are also encircled by a perimeter of solid conductive trace material to provide a ground ring 25.

In an environment with pervasive ambient spurious noise or interference signals, the balanced pad design exhibits noise or Electro Magnetic Interference (EMI) immunity through common mode rejection, wherein the center pad and the outer ring electrode each have a substantially equal spurious noise or interference signal receiving area. This signal receiving area is, for thin conductive traces, equivalent to conductor surface area. Ambient spurious noise or interference signals cause substantially identical induced spurious noise or interference signals to be generated in the inner electrode and the outer electrode. Since the equal or balanced receiving area is affected by spurious noise or interference signals substantially equally, when one electrode's signal is essentially subtracted from the other electrode's signal, the induced spurious noise/interference signals from the first and second electrodes, being common to both electrodes and of substantially equal amplitude, cancel one another.

FIG. 2 is drawn to scale and illustrates that center electrode 22 comprises a plurality of conductive trace segments defining a closed rectangular box-shaped periphery including four walls 22a, 22b, 22c and 22d surrounding ten parallel, elongate conductive segments 22e, 22f, 22g, 22h, 22i, 22j, 22k, 22l, 22m and 22n separated from one another along their lengths by segments of non-conductive substrate surface and connected via at least one end to at least one of the surrounding walls 22a, 22b, 22c and 22d. In the embodiments of FIGS. 2 and 3, inner electrode 22 includes a central region having no conductive trace surface area defined by gaps between opposing conductive segments (22g and 22j, 22h and 22k, 22i and 22l), to provide an inner electrode 22 having substantially the same surface or plan view area as outer electrode 24. The gap in the central region may be used with a light transmissive substrate to allow light to pass through the center of the pad area, for a lighted touch sensor.

The shorter conductive segments arranged to leave a gap there between (e.g., such as 22g and 22j) may be configured with rounded distal ends, as shown, or may have pointed distal ends or squared distal ends.

FIG. 3 illustrates the component side layout of conductive traces on printed circuit board 21 including balanced pad inner electrode 22 and outer electrode 24 with ground ring 25 patterned in conductive trace material (e.g., copper foil) to be contiguous with a conductive ground plane 32. The embodiment of FIG. 3 provides added shielding to further reduce the effects of EMI.

In the embodiments illustrated in FIGS. 2 and 3, the dark traces indicate the position of conductive trace material such as copper foil, deposited copper, or a tinned or soldered conductive material. Substantially rectangular balanced inner pad 22 has a horizontal extent of approximately twelve millimeters (mm) and a vertical extent of approximately nine mm. The inner electrode pad 22 parallel conductive traces 22e-22m are each approximately one mm in width and are separated by approximately equal width sections of non-conductive PCB surface, where each conductive trace is connected at one or both ends by surrounding conductive trace material to a resistor (e.g., R1 for pad 22, as shown in the schematic of FIG. 4). Inner electrode 22 is not quite completely encircled by upper outer electrode 24 which is approximately 1.5 mm in width and is connected to a “TS100” touch sensor ASIC 30. Sensor ASIC 30 is connected between the inner electrode 22 and outer electrode 24 and acts to amplify and buffer the detection signal at the sensor, thereby reducing the difference in signal level between individual sensors due to different lead lengths and lead routing paths.

The ASIC 30 connected to the field effect sensor's balanced electrodes is an active device and, in the illustrated embodiment, is preferably configured to operate in the manner described in U.S. Pat. No. 6,320,282, to Caldwell, the entire disclosure of which is incorporated herein by reference. As described above, a simple balanced field effect cell has two electrodes (e.g., 22, 24), an ASIC (e.g., 30) and two gain tuning resistors (34 and 36). The pin-out for the TS-100 ASIC of the invention is similar to that illustrated in FIG. 4 of the '282 patent, but the pin-outs vary slightly. The TS-100 ASIC is available from Touch Sensor LLC. Specifically, for the TS-100 ASIC shown in this application, The input power (Vdd) connection is on pin 1, the ground connection is on Pin 2, the sensor signal output connection is on pin 3, the outer electrode resistor (e.g., 36) is connected to pin 4, the “oscillator out” connection is at pin 5 and the inner pad electrode resistor (e.g., 34) is connected to pin 6. Optionally, an ASIC can be configured to eliminate the need for gain tuning resistors 34 and 36 by making the gain tuning adjustments internal to the ASIC.

The sensitivity of the field effect sensor or cell is adjusted by adjusting the values of gain tuning resistors 34 and 36.

The sensor of the present invention can be adapted for use in a variety of applications and the gain resistors can be changed to cause a desired voltage response. The sensor of the present invention is like other sensors in that the sensor's response to measured stimulus must be tuned or calibrated to avoid saturation (i.e., gain/sensitivity set too high) and to avoid missed detections (i.e., gain/sensitivity set too low). For most applications, a gain tuning resistor value which yields a sensor response in a linear region is preferred. The tuning method typically places the sensor assembly in the intended sensing environment and the circuit test points at the inputs to the decision circuit (e.g., points 90 and 91 as seen in FIG. 4 of Caldwell's '282 patent) are monitored as a function of resistance. The resistance value of the gain tuning resistors are adjusted to provide an output in the mid-range of the sensor's linear response.

Balanced touch sensor 20 was tested to determine whether enhanced EMI immunity or tolerance would result from the balanced pad configuration. FIG. 4 is a schematic diagram illustrating the circuit components and conductive traces as used with a tested balanced pad sensor electrode, in accordance with the present invention. The board layout and component placement are best shown in FIG. 5. Inner electrode 22 is connected in series with a first gain tuning or bias resistor 34 having a value to be selected later as part of the above described gain tuning process. Similarly, outer electrode 24 is connected in series with a second tuning or bias resistor 36 having a resistance value to be selected later as part of that tuning process. Tuning or bias resistors 34 and 36 are preferably surface mount devices rated at one sixteenth watt, having a tolerance of one percent (1%). As best seen in FIG. 4, tuning resistor 36 is also connected to strobe line 28. Inner electrode 22 is connected to touch sensor integrated circuit 30 on pin 6, the sense line for the inner electrode. Outer electrode 24 is connected to touch sensor integrated circuit 30 on pin 4, the sense line for the outer electrode. Inner electrode 22 and outer electrode 24 are also connected via bias resistors 34 and 36 to touch sensor ASIC 30 on pin 5. An optional outer peripheral ground ring 25 at least partially surrounds outer electrode 24 and is preferably connected to a ground plane on PCB 21. Pin 1 of sensor IC 30 is connected to a five volt supply line regulated by 5.1 volt Zener diode 42 and filtered by capacitor 40 (0.1 μF, 16V) and capacitor 44 (also 0.1 μF, 16V). Optionally, a transformer 46 is connected to power supply input terminal 62 through a pair of series connected 150 ohm resistors 48, 50. Terminal 64 provides a ground connection and terminal 66 is the touch sensor signal terminal connected to sensor IC 30 via an optional choke 60 and series 10 ohm resistor 56. The signal line is filtered by capacitor 58 (0.1 μF, 16V), and a visual indication of sensor status is provided by light emitting diode (LED) 54 connected via 2KΩ resistor 52.

In the illustrated embodiment, an indicator signal is generated for the user upon human, fluid or metal contact with substrate 21, visually indicating the sensed condition and activation of any controlled device 67 to be integrated with sensor 20. Controlled device 67 may be, for example, a bilge pump activated when bilge fluid level is sensed or detected at a sensor location, an appliance motor or heating element activated when a user's finger or other appendage is sensed, or a solenoid or motor activated when a metal object is detected at a selected position (e.g., along a track). Sensor IC 30 is an active electrical component and is electrically coupled to first and second electrodes 22, 24, such that human, metal or liquid contact with substrate 21 activates any controlled device 67 integrated with balanced sensor 20.

Referring now to the circuit layout of FIG. 5 and the conductive patterns of FIGS. 2 and 3, when tuning a prototype touch sensor 20 for a selected application, a technician selects values of tuning or biasing resistors 34, 36 to provide acceptable levels of sensitivity in the prototype sensor. For a given sensor 20, tuning resistors 34, 36 having the selected values are soldered in place between the sensor IC 30 and the area on PCB 21 occupied by the balanced pad electrodes 22, 24. The balanced touch sensor 20 is more easily tuned than non-balanced electrode configurations, and the tuning process is more likely to provide repeatable sensing performance. Once the tuning resistor values have been established, those tuning resistor values can be used for manufacturing large numbers of sensors.

The circuitry used to energize the electrodes and sense a change in the arc-shaped electric field 27 generated by the electrodes may be created using discrete components but is optionally incorporated into an integrated circuit (IC) or chip referred to as a TS100 chip and used to sense the presence of a human appendage (e.g., a finger), a metal object or a fluid interface with air. In the exemplary embodiment, the TS100 is used with a conductive printed circuit for the active sensor area with an inner electrode 22 and outer ring electrode 24 connected to the TS100 via biasing resistors 34, 36 and driven with a time varying field. A differential change in the resulting arc-shaped electric field is sensed through the inner and outer electrodes 22, 24. Prior electrodes or pads were of un-equal surface area and were observed to exhibit relatively poor immunity to EMI. The balanced, equal area electrodes (i.e., inner pad 22 and outer ring 24) have, preferably, identical surface (or plan view) areas and result in a pad design that is highly immune to or tolerant of EMI. This EMI tolerance is also useful in configuring systems to meet stringent EMC criteria.

The balanced pad design and method of the present invention is also well suited for applications requiring the sensor(s) to be potted or sealed in an over molded enclosure, because the potting or molding process affects balanced differential electrodes (e.g., 22, 24) equally and makes tuning the sensor with biasing resistors 34, 36 more predictable and repeatable. Balanced pad touch sensor 20 provides a more consistent, repeatable performance over time and over a wider range of environmental conditions including changes in temperature, humidity and presence of contamination.

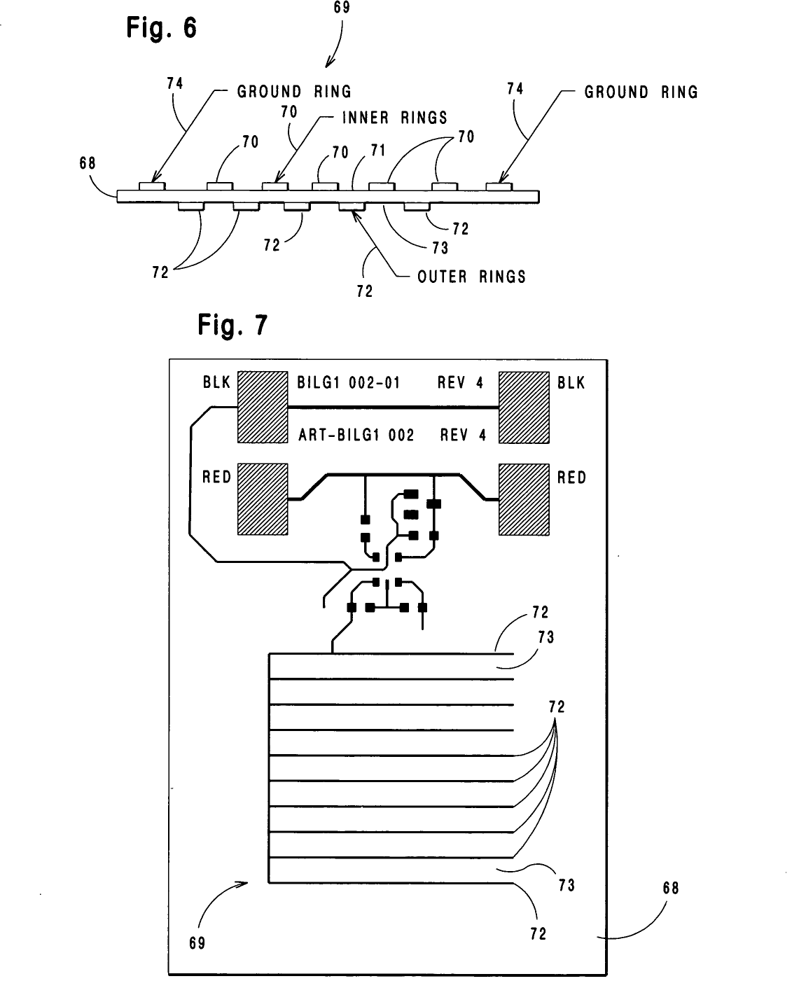

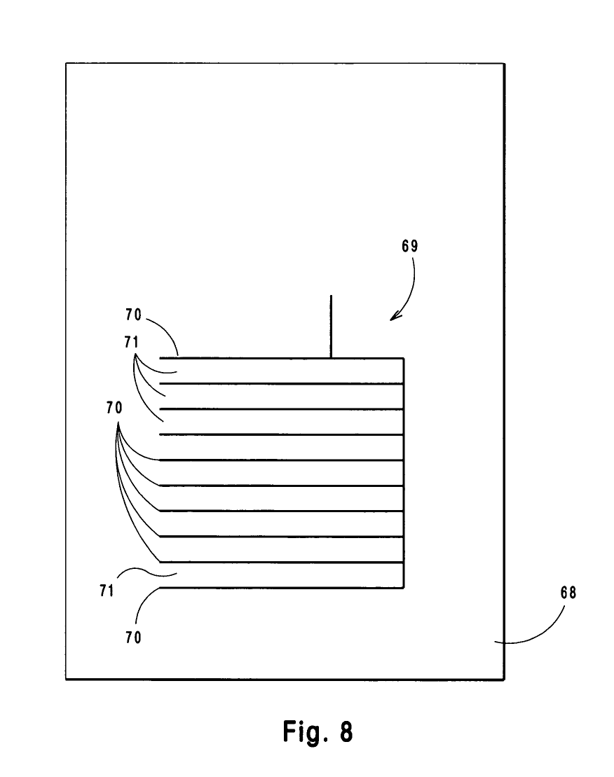

In a second embodiment best seen in FIGS. 6, 7 and 8, both sides of a two-sided printed circuit board 68 make a double-sided balanced electrode pattern 69 having first electrode traces 70 on a first side of PCB 68 opposite second electrode traces 72 on the second side of PCB 68. As best seen in FIGS. 6, 7 and 8, double-sided balanced electrode pattern 69 includes a component side layout (best seen in FIG. 7) with conductive traces for the second electrode 72 in evenly spaced lines on one side of PCB 68; the lines are separated by evenly spaced non-conductive channels 73. FIG. 8 shows the other side of PCB 68 carrying conductive traces for the first electrode 70 in evenly spaced lines, and showing the non-conductive channels 71 between the traces. The side elevational view of FIG. 6 shows that the electrode patterns are offset slightly so that each first electrode conductive trace 70 is positioned opposite a second side non-conductive channel segment 73 and between adjacent second electrode traces 72 on either side of the channel, and each second electrode conductive trace 72 is positioned opposite a first side non-conductive channel segment 71 and between adjacent first electrode traces 70 on either side of each channel 71. First electrode trace 70 and second electrode trace 72 are of substantially equal area.

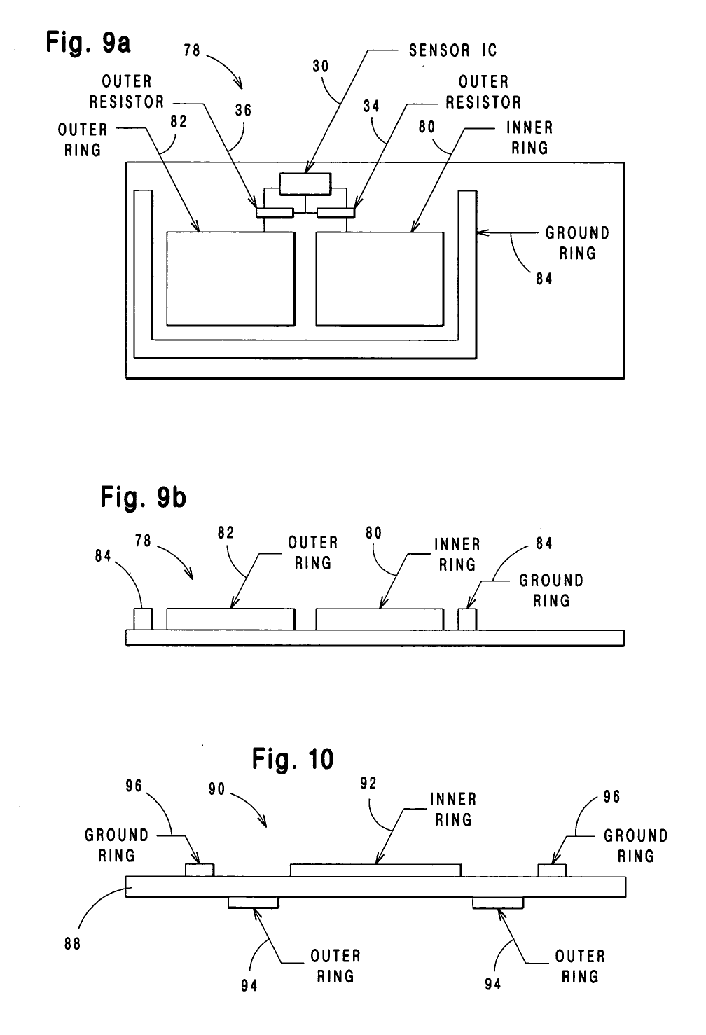

In a third embodiment best seen in FIGS. 9a and 9b, flat balanced pad sensor electrode pattern 78 includes a first electrode pad 80 situated on one side of a PCB and alongside a second electrode 82. FIG. 9a illustrates flat balanced pad sensor electrode pattern 78 with offset electrodes 80, 82. FIG. 9b shows a cross section side elevation view of the flat balanced pad sensor electrode pattern 78 with offset electrodes 80, 82 and a three sided or U-shaped ground ring 84. First electrode 80 and second electrode 82 are thin traces of conductive material of substantially surface equal area. As with the embodiments described above, first electrode 80 is connected via a first biasing or tuning resistor 34 to sensor IC 30 and second electrode 82 is connected via a second biasing or tuning resistor 36 to sensor IC 30.

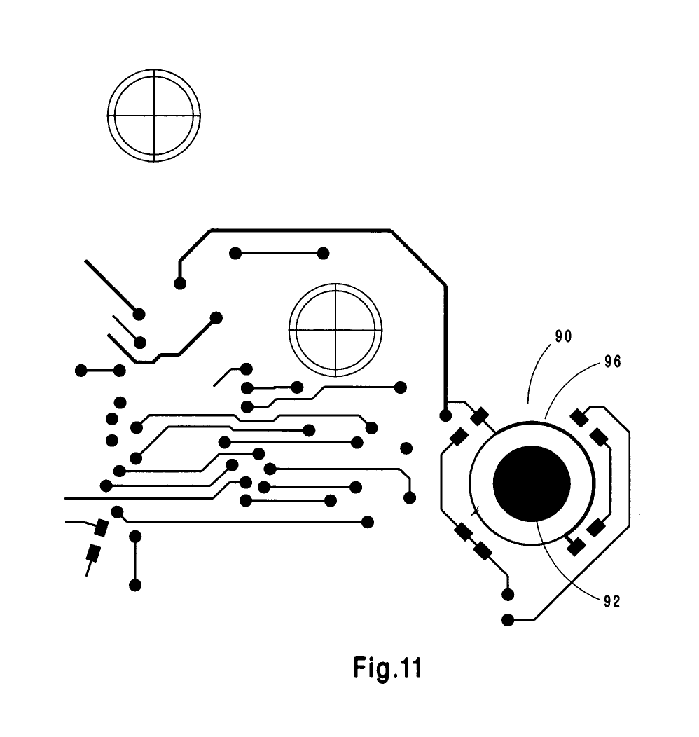

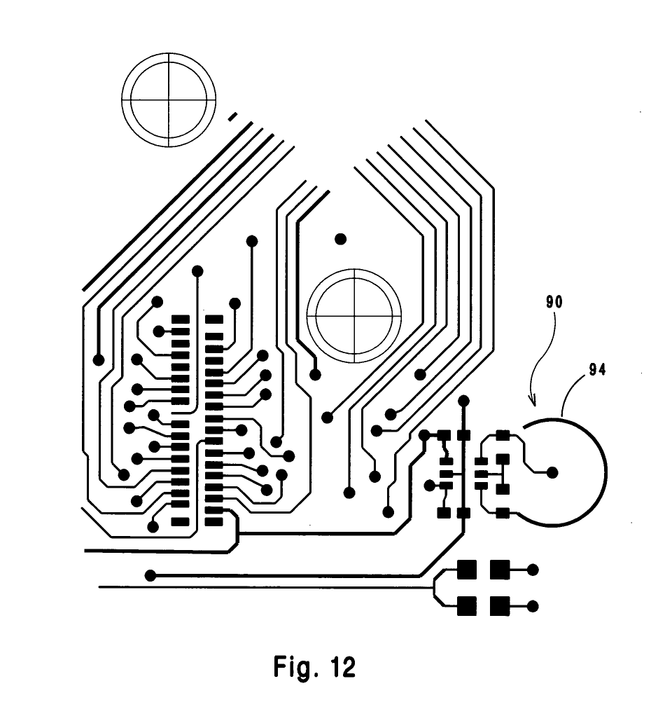

Other embodiments using the two sided PCB are also suitable for use in a variety of applications. FIGS. 10, 11 and 12 illustrate a balanced pad sensor electrode pattern 90 with inner ring electrode 92 on the opposite side of printed circuit board 88 from outer ring electrode 94. FIG. 11 is a diagram drawn to scale and illustrating the bottom side layout of conductive traces on the printed circuit board of FIG. 10, a side elevation cross sectional view. Two-sided printed circuit board 88 supports a two-sided balanced electrode pattern 90 having a solid inner circular electrode trace 92 on a first side of PCB 88 opposite an larger diameter outer ring electrode trace 94 on the second side of the PCB. As best seen in FIGS. 10 and 11, a circular conductive ground ring 96 is arranged around solid inner circle electrode trace 92 and has a larger diameter than outer ring electrode trace 94 on the second side of the PCB. FIG. 12 is a diagram drawn to scale and illustrating the top side layout of conductive traces on printed circuit board 88. First, electrode 90 and second electrode 94 are thin conductive traces of substantially equal surface area, and, as with the embodiments described above, first electrode 90 is connected via a first biasing or tuning resistor 34 to sensor IC 30 and second electrode 94 is connected via a second biasing or tuning resistor 36 to sensor IC 30.

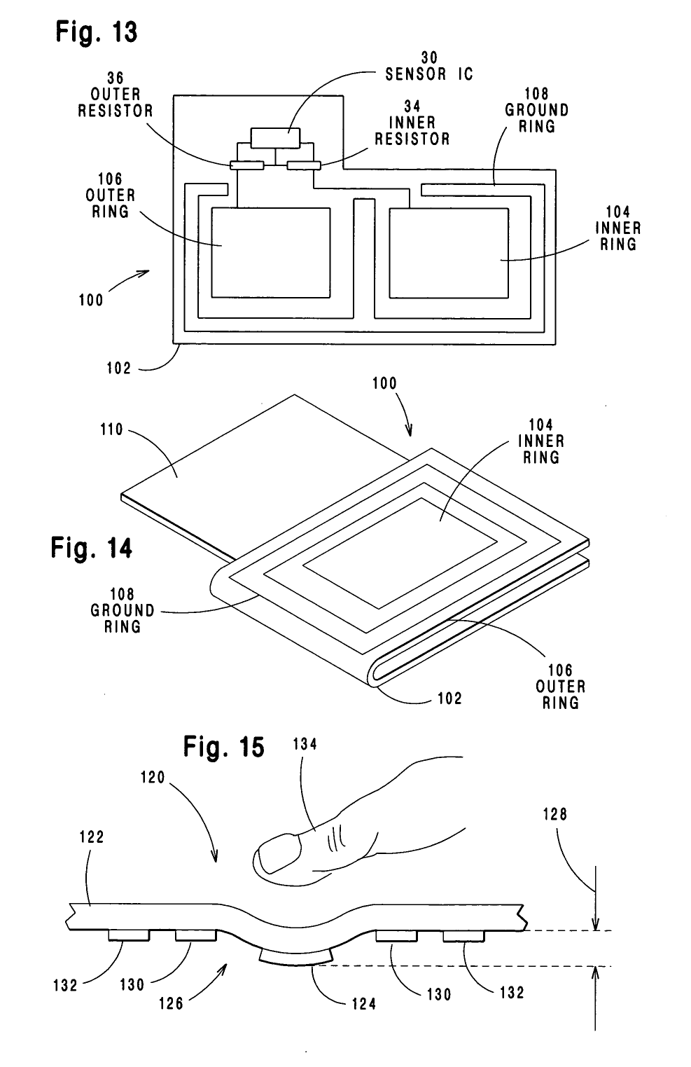

The balanced electrode design can be implemented on rigid, planar circuits, or can be incorporated into complex three dimensional configurations using, for example, flexible substrates folded, molded or otherwise shaped into a three dimensional (3-D) arrangement to provide directional sensing. FIG. 13 is a top plan view of a balanced pad sensor electrode pattern 100 implemented on a flexible substrate 102.

A sensor can be used with the electrodes 104, 106 in side by side orientation as shown in FIG. 13. Side by side configurations are useful for sensing things traveling along a selected path where one of the electrodes (e.g., 104) is placed in close proximity to the path. For purposes of nomenclature, “side by side” shall be construed broadly to mean any spaced electrode orientation that is not co-axial or concentric, such that the second electrode does not surround or encircle the first pad electrode. The first electrode and second electrode can be dimensioned and spaced such that, when side by side, the non-conductive space between the electrodes is substantially rectangular, triangular or irregular.

Alternatively, by folding the flexible PCB or substrate 102 to place the electrodes in different planes, a three dimensional (3-D) geometry that coaxially aligns inner electrode 104 and outer electrode 106 over one another along an aiming axis permits aimed or directional sensing. Many 3-D shapes are possible. FIG. 14 is a perspective view illustrating the balanced pad sensor electrode pattern design 100 with flexible substrate 102 arranged around a form or placard and wrapped in a three-dimensional configuration to coaxially align inner electrode 104 and outer electrode 106 over one another along an aiming axis and at a selected electrode-to-electrode spacing such as 0.0715 inches. This spacing is preferably controlled by a former or shim 110 having a thickness equal to the selected spacing. Coaxially aligned or stacked electrodes can also be aligned along a diagonal, with or without a ground ring to enhance sensitivity of the sensor cell in a direction through the substrate while minimizing the space occupied by the cell.

FIG. 15 illustrates an edge view of a focused sensitivity balanced touch sensor 120 having a dimpled substrate 122 wherein the inner pad electrode 124 is carried on an offset transverse projecting dimple 126. Dimple or protuberance 126 is offset from the plane of the remainder of the substrate by a selected offset distance 128, and outer electrode 130 and ground ring 132 are carried on the planar portion of substrate 122. The focused sensitivity balanced touch sensor 120 is preferably tuned to permit detection and the requisite sensor state change when a user's finger 134 presses the substrate proximate the dimple 126, but is not actuated and does not respond with a state change when the user lays a large appendage such as an arm over the whole sensor 120.

It will be appreciated by those of skill in the art that the method and sensor system of the present invention makes an EMI resistant and EMC standard compliant touch sensor available. The term “Balanced”, as used herein, means that when a first touch sensor electrode and a second touch sensor electrode are used together (e.g., in a differential circuit), the balanced nature of the noise or spurious signals on the first and second electrodes will effectively cancel one another, leaving the desired touch sensor signal.

Having described preferred embodiments of a new and improved method and structure, it is believed that other modifications, variations and changes will be suggested to those skilled in the art in view of the teachings set forth herein. It is therefore to be understood that all such variations, modifications and changes are believed to fall within the scope of the present invention as defined by the appended claims.

What is claimed is:

1. A low impedance, EMI resistant touch sensor apparatus for detecting human, metal or liquid contact and capable of activating a controlled device, said touch sensor apparatus comprising:
a dielectric substrate having first and second opposing surfaces;
a first conductive electrode pad disposed on said first surface of said substrate in a continuous form defining a selected pad surface area of conductive material;
a second conductive electrode disposed on said first surface of said substrate in a spaced, coplanar and substantially surrounding relationship to said first electrode pad, and defining a selected surface area of conductive material;
wherein said first electrode pad surface area is substantially equal to said second electrode surface area; and
an active electrical component disposed on said substrate proximate said first and second electrodes and electrically coupled to said first and second electrodes, such that human, metal or liquid contact with said substrate activates the controlled device.

2. The low impedance, EMI resistant touch sensor apparatus of claim 1 wherein an oscillator signal line is disposed on said substrate and electrically coupled to said second electrode.

3. The low impedance, EMI resistant touch sensor apparatus of claim 2 wherein a oscillator signal is applied to said oscillator line, said strobe signal creating an electric field between said first and second electrodes.

4. The low impedance, EMI resistant touch sensor apparatus of claim 3 wherein said electric field has an arc-shaped path originating at said second electrode and terminating at said first electrode.

5. The low impedance, EMI resistant touch sensor apparatus of claim 1 further including a sense line disposed on said substrate and connected to said first electrode.

6. The low impedance, EMI resistant touch sensor apparatus of claim 5 wherein said touch sensor generates a detection signal indicating the status of said touch sensor.

7. The low impedance, EMI resistant touch sensor apparatus of claim 6 wherein the level of said detection signal is altered when said human, metal or liquid contacts said substrate.

8. The low impedance, EMI resistant touch sensor apparatus of claim 1 wherein said substrate is made of a material selected from a group consisting of glass, plastic and fiberglass reinforced epoxy resin.

9. The low impedance, EMI resistant touch sensor apparatus of claim 1 wherein a channel is located between said first and second electrodes, said channel having a generally uniform width.

10. The low impedance, EMI resistant touch sensor apparatus of claim 1 wherein a plurality of said sensor electrodes are disposed on said first surface of said substrate.

11. A low impedance, EMI resistant touch sensor apparatus for detecting contact by a human or contact by metal or a liquid and capable of activating a controlled device, said touch sensor apparatus comprising:
a dielectric substrate having first and second opposite surfaces;
a first conductive electrode pad disposed on said substrate in a closed, continuous form having a selected conductive surface area to provide a region of contact;
a second conductive electrode disposed on said carrier in a spaced relationship to said first electrode and defining a selected second electrode conductive surface area;
wherein said first electrode's conductive surface area is substantially equal to said second electrode's conductive surface area;
an active electrical component disposed on said carrier proximate said first and second electrodes and electrically coupled to said first and second electrodes; and
such that human, metal or liquid contact with said substrate activates the controlled device.

12. The low impedance, EMI resistant touch sensor apparatus of claim 11 wherein said first surface of said substrate is a non touching surface and said second surface of said substrate is a touching surface.

13. The low impedance, EMI resistant touch sensor apparatus of claim 11 wherein said first surface of said substrate carries said first electrode and said second electrode side by side with said first electrode.

14. The low impedance, EMI resistant touch sensor apparatus of claim 13 wherein said substrate is flexible and adapted to conform to an arbitrary three dimensional shape.

15. The low impedance, EMI resistant touch sensor apparatus of claim 11, further including a light emitting diode disposed on said substrate proximate said first and second electrodes and electrically coupled to said first and second electrodes via said active electrical component, such that contact with said substrate visually indicates activation of the controlled device.

16. The low impedance, EMI resistant touch sensor apparatus of claim 11, further including at least one resistor disposed on said first surface of said substrate and electrically coupled between said first and second electrodes.

17. A sensor for detecting a human being's touch and capable of generating a control input detected signal for activating a controlled device, said sensor comprising:
a dielectric substrate of substantially uniform thickness having first and second opposite surfaces;
a first conductive electrode pad covering a selected area on said first surface of said substrate in a closed, continuous form having an area which affords substantial coverage for human contact with said substrate second surface;
a second conductive electrode covering a selected area on said first surface of said substrate in a spaced and substantially surrounding relationship to said first electrode pad;
an active electrical component disposed on said substrate proximate said first and second electrodes and electrically coupled to said first and second electrodes, such that human contact with said substrate second surface activates the controlled device;
wherein said first thin, conductive electrode pad disposed on said first surface of said substrate comprises a balanced pad electrode having a surface area that is substantially equal with the surface area of said second conductive electrode.

18. The sensor of claim 17, wherein said balanced pad electrode comprises a substantially planar electrode having a plurality of interconnected conductive traces separated by segments of non-conductive dielectric material.

19. The sensor of claim 18, wherein said balanced pad electrode has a substantially rectangular conductive perimeter.

20. The sensor of claim 17, wherein said substrate comprises a planar surface carrying a transverse protuberance, and wherein said balanced pad electrode is offset and disposed on said transverse protuberance and said second electrode is disposed on said substrate planar surface in substantially concentric alignment with said offset pad electrode.

21. A sensor for detecting a human being's touch and capable of generating a control input detected signal for activating a controlled device, said sensor comprising:
a dielectric substrate of substantially uniform thickness having first and second opposite surfaces;
a first conductive electrode pad covering a selected area on said first surface of said substrate in a closed, continuous form having an area which affords substantial coverage for human contact with said substrate second surface;
a second conductive electrode covering a selected area on said second surface of said substrate in a spaced and substantially surrounding relationship to said first electrode pad, when seen in plan view;
an active electrical component disposed on said substrate proximate said first and second electrodes and electrically coupled to said first and second electrodes, such that human contact with said substrate second surface activates the controlled device;
wherein said first conductive electrode pad comprises a balanced pad electrode having a surface area that is substantially equal with the surface area of said second conductive electrode.

22. The sensor of claim 21, wherein said balanced pad electrode comprises a substantially planar circular conductive electrode.

23. The sensor of claim 22, wherein said second conductive electrode comprises a surrounding substantially planar conductive electrode.

24. The sensor of claim 21, wherein said first electrode pad comprises a first array of parallel, elongate, substantially planar conductive electrode segments all connected at one end by a first transverse conductive segment and laterally separated by elongate non-conductive segments.

25. The sensor of claim 24, wherein said second conductive electrode comprises a second array of parallel, elongate, substantially planar conductive electrode segments all connected at one end by a second transverse conductive segment and laterally separated by elongate non-conductive segments, wherein said second array is offset from said first array on said substrate such that said first array of parallel, elongate, conductive electrode segments are each aligned with said second array's elongate non-conductive segments.

26. A method for processing touch sensor field effect signals, comprising:
(a) providing a dielectric substrate;
(b) providing a first conductive electrode pad covering a selected surface area on said substrate in a closed, continuous geometric form;
(c) providing a second conductive electrode pad covering a selected surface area on said substrate in a spaced relationship to said first electrode pad; wherein said first conductive electrode pad has a surface area that is substantially equal with the surface area of said second conductive electrode;
(d) generating an arc-shaped electric field between said first electrode and said second electrode;
(e) sensing changes in said electric field;
(f) sensing spurious or EMI signals on said first electrode and said second electrode; and
(g) rejecting said spurious or EMI signals when said spurious or EMI signals appear on both of said first and second electrodes.
